(19) United States
(12) Patent Application Publication
(10) Pub. No.: US 2025/0196912 A1
(43) Pub. Date: Jun. 19, 2025

(54) VEHICLE SUSPENSION SYSTEM

(71) Applicant: HYUNDAI MOBIS CO., LTD., Seoul (KR)

(72) Inventors: Jae Woong JEON, Yongin-si (KR); Jin Wook JOO, Yongin-si (KR)

(73) Assignee: HYUNDAI MOBIS CO., LTD., Seoul (KR)

(21) Appl. No.: 18/802,341

(22) Filed: Aug. 13, 2024

(30) Foreign Application Priority Data
Dec. 14, 2023 (KR) 10-2023-0181771

(51) Int. Cl. B62D 5/04; B60G 7/00; B60G 13/00; B60K 7/00; B62D 3/04; B62D 7/18

(52) U.S. Cl. CPC B62D 5/0418; B60G 7/005; B60G 13/001; B60K 7/0007; B62D 3/04; B62D 7/18; B60G 2204/416

(57) ABSTRACT

A vehicle suspension system includes a support member coupled to a vehicle body, a shock absorber connecting the support member and the vehicle body and absorbing the road surface impact, a steering section pivotably mounted on the support member, and an in-wheel motor section coupled to the steering section in an interworking manner and mounted on a wheel to provide driving force.

### CROSS-REFERENCE TO RELATED APPLICATION

The present application claims priority to and the benefit of Korean Patent Application No. 10-2023-0181771, filed on Dec. 14, 2023 in the Korean Intellectual Property Office, the entire disclosure of which is incorporated herein by reference.

### BACKGROUND

### Field

Embodiments of the present disclosure relate to a vehicle suspension system and, more particularly, to a vehicle suspension system in which a package space is secured, tie rods are eliminated to enable various driving modes, and front and rear wheels are available used in common.

### Description of the Related Art

In recent years, vehicles have become an extension of living space rather than a means of transportation, and purpose-built vehicles (PBVs) with spacious interiors are gaining attention. These purpose-built vehicles are expanding the interior space by applying in-wheel motors that directly drive the wheels by placing the drive motors inside respective wheels, rather than conventional electric vehicles with a drive motor in the place of an internal combustion engine. However, due to the in-wheel motor, the space inside the wheel becomes narrower than the conventional configuration, the turning radius increases, and the wheel alignment becomes worse during the large steering movement. Therefore, there is a need to improve the above problem.

The Background of the present disclosure is disclosed in Unexamined Korean Patent Publication No. 10-2019-0041855 entitled ‘Steering System for In-wheel Motor Vehicle’ (published on Apr. 23, 2019).

### SUMMARY

Various embodiments are directed to a vehicle suspension system in which a package space is secured, tie rods are eliminated to enable various driving modes, and front and rear wheels are available used in common.

In an embodiment, a vehicle suspension system includes: a support member coupled to a vehicle body; a shock absorber connecting the support member and the vehicle body and absorbing a road surface impact; a steering section pivotably mounted on the support member; and an in-wheel motor section coupled to the steering section in an interworking manner and mounted on a wheel to provide driving force.

The support member may include: an upper support part to which an upper portion of the steering section is coupled; and a lower support part to which a lower portion of the steering section is pivotably coupled.

The upper support part may include: an upper connection portion coupled to the steering section; an upper ball joint portion coupled to the upper connection portion; and a plurality of upper arm portions pivotably mounted in an axial direction of the upper ball joint portion and connected to the vehicle body.

The plurality of the upper ball joint portions may be spaced apart from each other, and the upper arm portions may be mounted on the upper ball joint portions, respectively.

The lower support part may include: a lower ball joint portion coupled to the steering section; and a lower arm portion on which the lower ball joint portion is pivotably mounted, which is coupled to the vehicle body, and to which the shock absorber is connected.

The steering section may include: a steering housing part combined with the in-wheel motor section; a steering gear part pivotably accommodated in the steering housing part and coupled to the support member; and a steering motor part mounted on the steering housing part to provide rotational force to the steering gear part.

The steering housing part may include: a first housing portion combined with the steering motor part to accommodate the steering gear part therein and having an upper housing hole; a second housing portion that is combined with the first housing portion to cover the housing hole and through which a portion of the steering gear part passes; a third housing portion extending from the first housing portion and combined with the in-wheel motor section; and a fourth housing portion extending from the third housing portion and combined with the support member.

The steering housing part may further include: a fifth housing portion formed in the second housing portion and meshed with a portion of the steering gear part.

The steering gear part may include: a worm gear pivotably mounted on the steering housing part and meshed with the steering motor part to rotate therewith; a sun gear interlocked with the worm gear to rotate therewith; a plurality of planetary gears circumferentially disposed around the sun gear in a mutually meshed manner to rotate therewith; a carrier supporting the plurality of the planetary gears and fixed to the support member through the steering housing part; and a ring gear disposed around the planetary gears and connected to the steering housing part to output rotational force to the steering housing part.

The steering motor part may include: a motor casing portion mounted on the steering housing part; a motor drive portion accommodated in the motor casing portion; and a motor shaft portion connected to the motor drive portion and inserted into the steering housing part to provide rotational force to the steering gear part.

In the vehicle suspension system according to the present disclosure, since the steering section is pivotably supported on the support member and the steering angle of the wheel and the in-wheel motor section coupled to the steering section is independently regulated, tie rods are eliminated to implement various driving modes as well as to improve driving stability.

### BRIEF DESCRIPTION OF THE DRAWINGS

FIG. 1 is a diagram schematically illustrating a vehicle suspension system according to an embodiment of the present disclosure;

FIG. 2 is a diagram schematically illustrating a support member according to an embodiment of the present disclosure;

FIG. 3 is a perspective diagram schematically illustrating an upper support part according to an embodiment of the present disclosure;

FIG. 4 is a cross-sectional view taken along line A-A in FIG. 3;

FIGS. 5A to 5C are a diagram schematically illustrating an arrangement of the upper support part according to an embodiment of the present disclosure;

FIG. 6 is a perspective diagram schematically illustrating a lower support part according to an embodiment of the present disclosure;

FIG. 7 is a cross-sectional view taken along line B-B in FIG. 6;

FIG. 8 is an exploded perspective diagram schematically illustrating a steering section according to an embodiment of the present disclosure;

FIG. 9 is a perspective assembly diagram schematically illustrating a steering housing part according to an embodiment of the present disclosure;

FIG. 10 is an exploded perspective diagram schematically illustrating a steering housing part according to an embodiment of the present disclosure;

FIG. 11 is a perspective assembly diagram schematically illustrating a steering gear part according to an embodiment of the present disclosure;

FIG. 12 is an exploded perspective diagram schematically illustrating a steering gear part according to an embodiment of the present disclosure;

FIG. 13 is a cross-sectional diagram schematically illustrating a steering gear part according to an embodiment of the present disclosure; and

FIG. 14 is a diagram schematically illustrating a steering motor part according to an embodiment of the present disclosure.

### DETAILED DESCRIPTION OF THE ILLUSTRATED EMBODIMENTS

Hereinafter, a vehicle suspension system according to embodiments of the present disclosure will be described with reference to the accompanying drawings. In the description, the thicknesses of the lines or the sizes of the components illustrated in the drawings may be exaggerated for clarity and convenience of explanation. In addition, the terms to be described later are terms defined in consideration of functions in the present disclosure, which may vary depending on the intention of a user or an operator, or a usual practice in the art. Therefore, definitions of these terms should be made based on the entire contents of this specification.

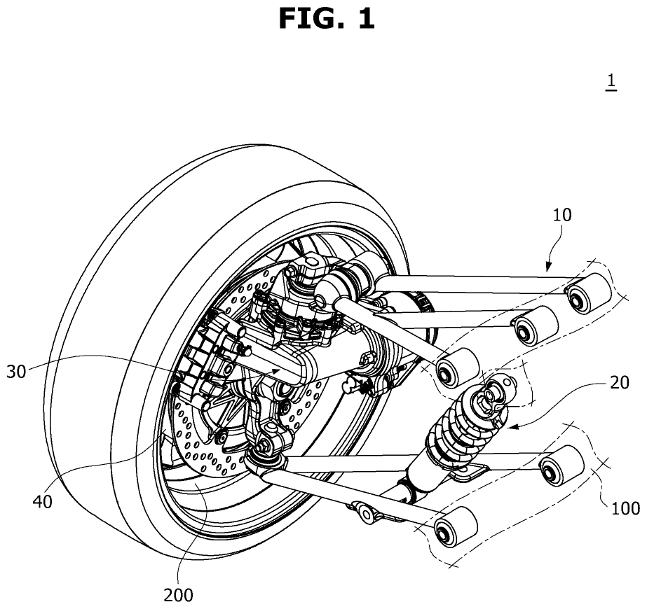

FIG. 1 is a diagram schematically illustrating a vehicle suspension system according to an embodiment of the present disclosure. Referring to FIG. 1, the vehicle suspension system 1 includes a support member 10, a shock absorber 20, a steering section 30, and an in-wheel motor section 40.

The support member 10 may be coupled to a vehicle body 100. In an example, two support members 10 may be disposed upwardly and downwardly, respectively.

The shock absorber 20 may connect the support member 10 and the vehicle body 100 and may absorb the road surface impact. In an example, the shock absorber 20 may have an upper part coupled to the vehicle body 100 and a lower part coupled to the support member 10. The shock absorber 20 may adjust its own length with hydraulic or spring force to absorb shocks.

The steering section 30 may be pivotably mounted on the support member 10. The steering section 30 may be supported on the support member 10 and may provide power to turn and steer a wheel 200 when powered.

The in-wheel motor section 40 may be coupled to the steering section 30 in an interworking manner. The in-wheel motor section 40 may be mounted on the wheel 200 to provide driving power. In an example, the in-wheel motor section 40 is mounted the inside the wheel 200 and may include a stator and a rotor.

By providing each wheel 200 with the in-wheel motor section 40 and the steering section 30 coupled to the in-wheel motor section 40, each wheel 200 may be independently steered. Since the steering section 30 combined with the in-wheel motor section 40 is supported on the support member 10 to adjust the steering angle of the wheel 200, it is possible to eliminate tie rods, thereby increasing the interior space of a vehicle and realizing various driving modes (zero-turn, diagonal driving, crab driving).

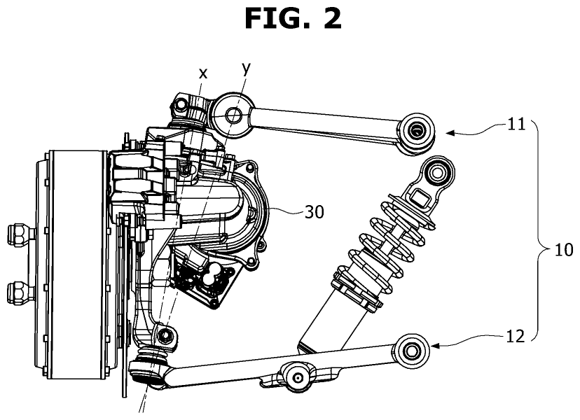

FIG. 2 is a diagram schematically illustrating a support member according to an embodiment of the present disclosure. Referring to FIG. 2, the support member 10 may include an upper support part 11 and a lower support part 12.

An upper portion of the steering section 30 may be coupled to the upper support part 11. In an example, the upper support part 11 combined with the upper portion of the steering section 30 may limit a portion of rotation of the steering section 30. The upper support part 11 may be pivotably coupled to the vehicle body 100.

A lower portion of the steering section 30 may be pivotably coupled to the lower support part 12. In an example, the lower support part 12 combined with the lower portion of the steering section 30 may induce axial rotation of the steering section 30.

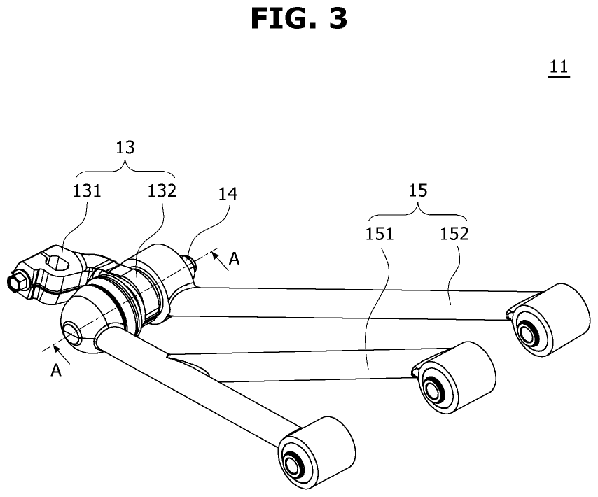

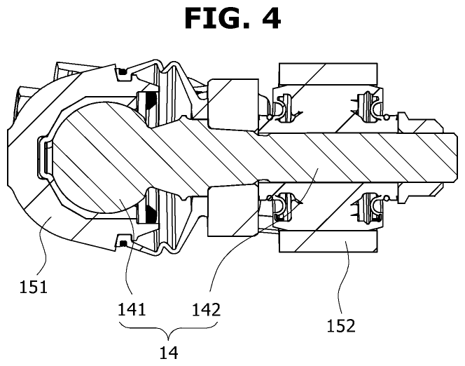

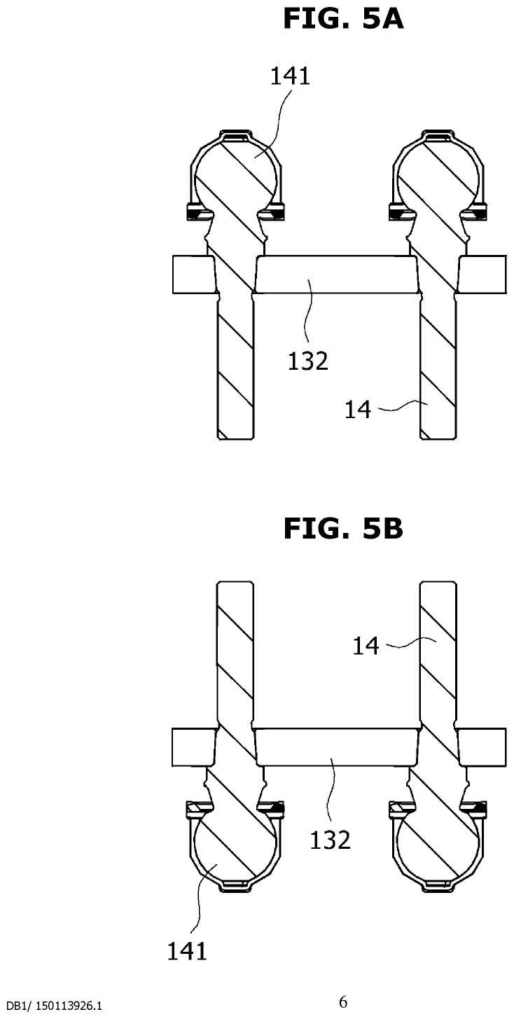

FIG. 3 is a perspective diagram schematically illustrating an upper support part according to an embodiment of the present disclosure, FIG. 4 is a cross-sectional view taken along line A-A in FIG. 3, and FIGS. 5A to 5C are a diagram schematically illustrating an arrangement of the upper support part according to an embodiment of the present disclosure. Referring to FIGS. 3 to 5, the upper support part 11 may include an upper connection portion 13, an upper ball joint portion 14, and an upper arm portion 15.

The upper connection portion 13 may be coupled to the steering section 30. In an example, the upper connection portion 13 may include a first upper connection portion 131 partially interlocked with a steering gear portion of the steering section 30 to partially restrict rotation of the gear portion, and a second upper connection portion 132 extending from the first upper connection portion 131.

The upper ball joint portion 14 may be coupled to the upper connection portion 13. In an example, the upper ball joint portion 14 may include an upper ball portion 141 having a spherical shape and an upper stud portion 142 extending from the upper ball portion 141.

A plurality of upper arm portions 15 may be pivotably mounted in an axial direction of the upper ball joint portion 14. The upper arm portion 15 may be connected to the vehicle body 100. In an example, the upper arm portion 15 may include a first upper arm 151 coupled to the upper ball portion 141 so as to be rotatable about the axial direction of the upper ball joint portion 14, and a second upper arm 152 coupled to the upper stud portion 142 so as to be rotatable about the axial direction of the upper ball joint portion 14. The first upper arm 151 and the second upper arm 152 may be pivotably mounted on the vehicle body 100.

Additionally, a plurality of upper ball joint portions 14 may be coupled to the upper connection portion 13. In this case, the upper arm portions 15 may be mounted on the upper ball joint portions 14, respectively. In an example, the second upper connection portion 132 combined with the two upper ball joint portions 14 may be constrained to rotate only in the axial direction connecting the center portions of the two upper ball joint portions 14, so that the upper connection portion 13 is fixed during steering. In this case, each of the upper ball joint portions 14 may be coupled not only directly but also in various orientations depending on the vehicle package and joint geometry. That is, the upper ball portions 141 of the upper ball joint portions 14 may be disposed on the upper side (see FIG. 5A) or on the lower side (see FIG. 5B) of the second upper connection portion 132. In addition, the upper ball portions 141 of the upper ball joint portions 14 may be disposed on the upper side and the lower side of the second upper connection portion 132, respectively (see FIG. 5C). Further, the above components may be combined in various ways to provide a ball-joint behavior. For example, a ball stud-ball stud connection, a ball stud-pillowball bushing connection, or a bushing-bushing connection may be made.

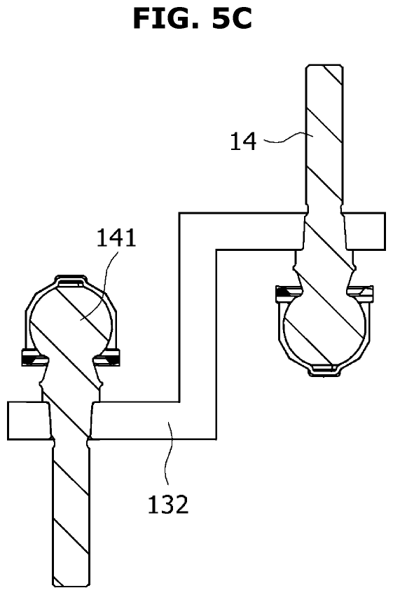

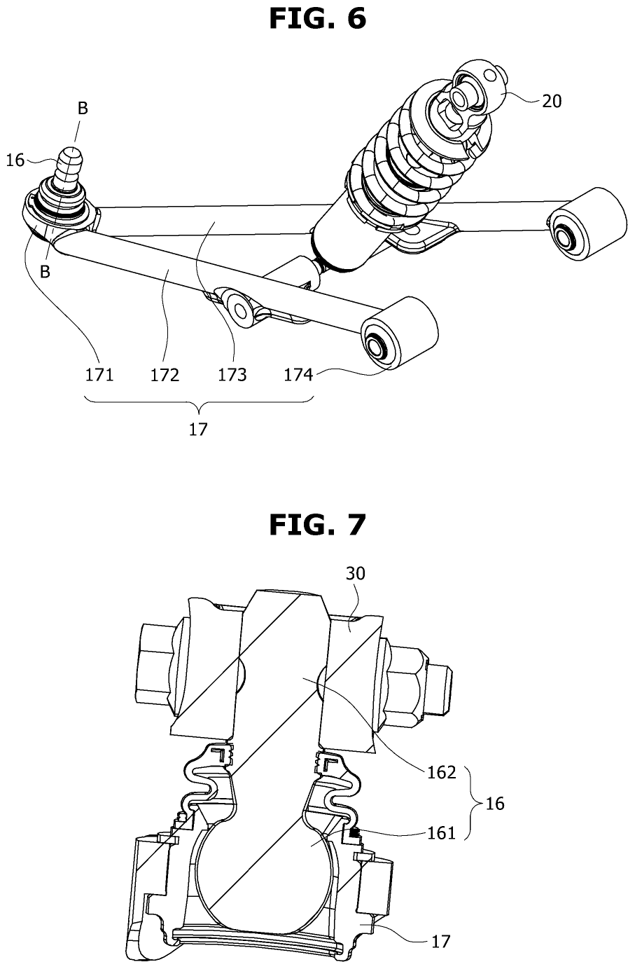

FIG. 6 is a perspective diagram schematically illustrating a lower support part according to an embodiment of the present disclosure, and FIG. 7 is a cross-sectional view taken along line B-B in FIG. 6. Referring to FIGS. 6 and 7, the lower support part 12 may include a lower ball joint portion 16 and a lower arm portion 17.

The lower ball joint portion 16 may be coupled to a lower portion of the steering section 30. In an example, the lower ball joint portion 16 may include a lower ball portion 161 having a spherical shape and a lower stud portion 162 extending from the lower ball portion 161. The lower stud portion 162 may be coupled to a lower portion of the steering section 30, and the lower ball portion 161 may be disposed on a lower side of the steering section 30.

The lower ball joint portion 16 may be pivotably mounted on the lower arm portion 17. The lower arm portion 17 is coupled to the vehicle body 100 and the shock absorber 20 may be connected thereto. In an example, the lower arm portion 17 may include a first lower arm 171 pivotably coupled to wrap around the lower ball portion 161, a second lower arm 172 and a third lower arm 173 extending from the first lower arm 171, and fourth lower arms 174 formed at ends of the second lower arm 172 and the third lower arm 173 and pivotably coupled to the vehicle body 100. The shock absorber 20 may be combined with the second lower arm 172 and the third lower arm 173.

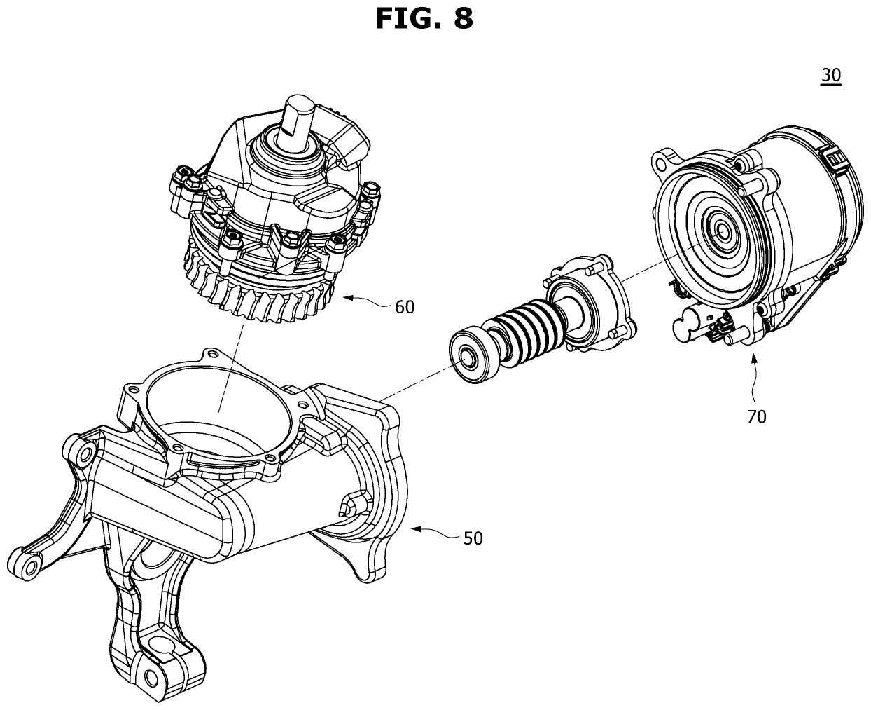

FIG. 8 is an exploded perspective diagram schematically illustrating a steering section according to an embodiment of the present disclosure. Referring to FIG. 8, the steering section 30 may include a steering housing part 50, a steering gear part 60, and a steering motor part 70.

The steering housing part 50 may be combined with the in-wheel motor section 40. In an example, like a conventional knuckle, the steering housing part 50 may support the wheel 200 and a tire, and may change the direction of the wheel 200.

The steering gear part 60 may be rotatably accommodated in the steering housing part 50, and may be coupled to the support member 10. In an example, a portion of the steering gear part 60 may be fixedly coupled to the upper support part 11, thereby allowing the steering housing part 50 itself to rotate.

The steering motor part 70 may be mounted on the steering housing part 50 to provide rotational force to the steering gear part 60. In an example, when powered, the steering motor part 70 may generate power.

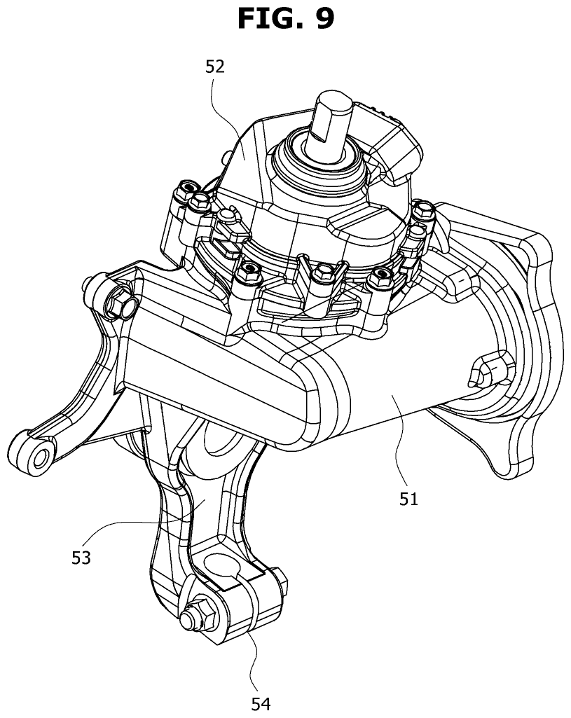

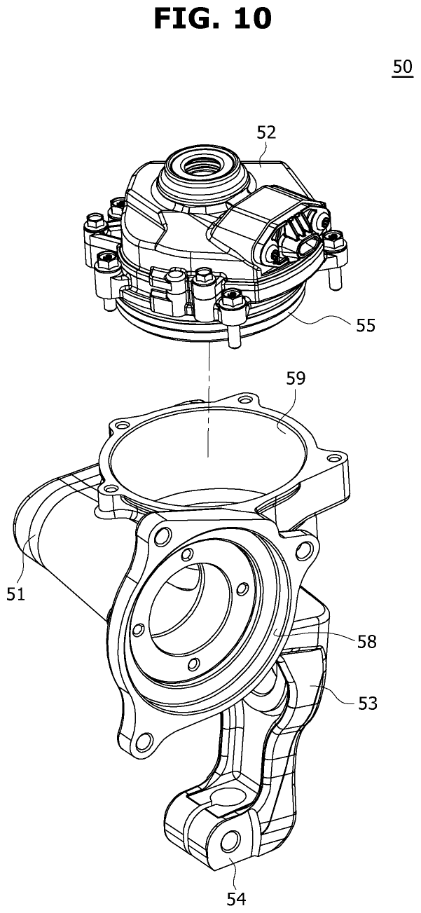

FIG. 9 is a perspective assembly diagram schematically illustrating a steering housing part according to an embodiment of the present disclosure, and FIG. 10 is an exploded perspective diagram schematically illustrating a steering housing part according to an embodiment of the present disclosure. Referring to FIGS. 9 and 10, the steering housing part 50 may include a first housing portion 51, a second housing portion 52, a third housing portion 53, and a fourth housing portion 54.

The first housing portion 51 may be combined with the steering motor part 70. A housing hole 59 may be formed in an upper side of the first housing portion 51. In an example, the first housing portion 51 may have an internal space for accommodating the steering gear part 60. A connection hole 58 may be formed on the side of the first housing portion 51.

The second housing portion 52 may be coupled to the first housing portion 51 to cover the housing hole 59. A portion of the steering gear part 60 may pass through the second housing portion 52. In an example, a seal may be provided between the second housing portion 52 and the steering gear part 60 to prevent foreign matter from entering.

The third housing portion 53 may extend from the first housing portion 51 and may be combined with the in-wheel motor section 40.

In an example, the third housing portion 53 may extend downwardly from the first housing portion 51 and may be combined with the central portion of the in-wheel motor section 40.

The fourth housing portion 54 may extend from the third housing portion 53 and may be combined with the support member 10. In an example, the fourth housing portion 54 may extend laterally from the lower portion of the third housing portion 53 and may be combined with the lower stud portion 162.

According to an embodiment of the present disclosure, the steering housing part 50 may further include a fifth housing portion 55. The fifth housing portion 55 may be formed in the second housing portion 52 and may engage with a portion of the steering gear part 60. In an example, the fifth housing portion 55 may extend downwardly from the second housing portion 52. The fifth housing portion 55 may be integrally formed with the second housing portion 52 or may be separately molded and then combined with the second housing portion 52. When the second housing portion 52 is coupled to the first housing portion 51, the fifth housing portion 55 may pass through the housing hole 59 and spline-engage with an output of the steering gear part 60. Accordingly, rotational force of the steering gear part 60 may be transferred to the steering housing part 50 to rotate the steering housing part 50 and the in-wheel motor section 40 connected to the steering housing part 50 to adjust the steering angle of the wheel 200.

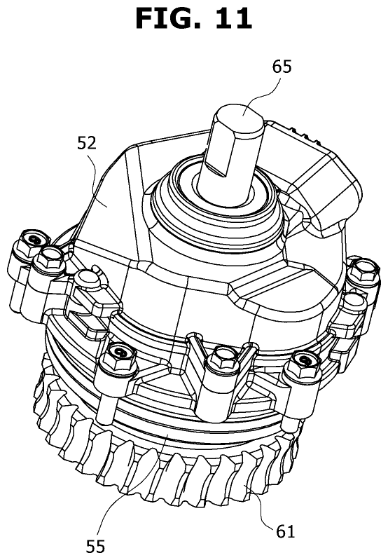

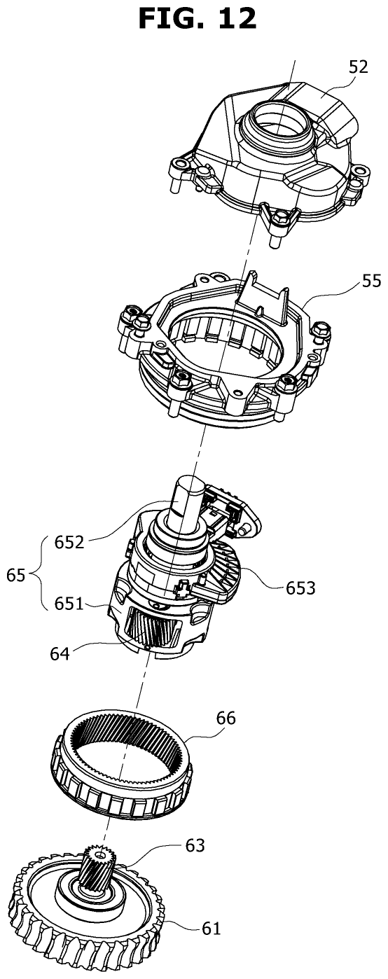

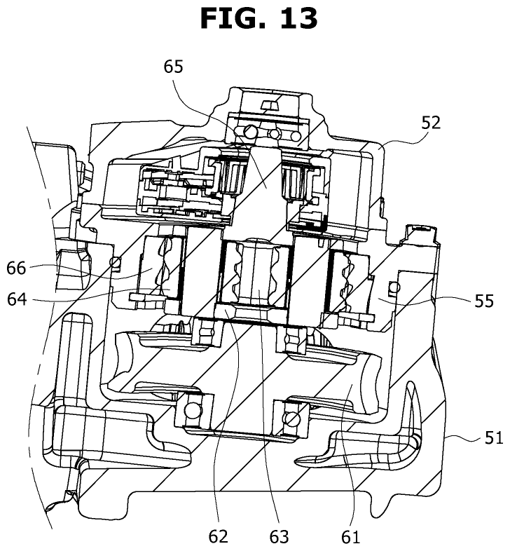

FIG. 11 is a perspective assembly diagram schematically illustrating a steering gear part according to an embodiment of the present disclosure, FIG. 12 is an exploded perspective diagram schematically illustrating a steering gear part according to an embodiment of the present disclosure, and FIG. 13 is a cross-sectional diagram schematically illustrating a steering gear part according to an embodiment of the present disclosure. Referring to FIGS. 11 to 13, the steering gear part 60 may include a worm gear 61, a sun gear 63, a planetary gear 64, a carrier 65, and a ring gear 66.

The worm gear 61 may be pivotably mounted on the steering housing part 50 and may be interlocked with the steering motor part 70 to rotate therewith. In an example, the worm gear 61 may have circumferentially formed gear teeth. The worm gear 61 may be rotatably supported by a bearing.

The sun gear 63 may be rotated in connection with the worm gear 61, and a plurality of planetary gears 64 may be circumferentially disposed around the sun gear 63. The sun gear 63 may extend from a center shaft of the worm gear 61. The sun gear 63 may be integrally molded with the worm gear 61. The planetary gears 64 may be rotatably interlocked with the outer circumferential surface of the sun gear 63.

The carrier 65 may support the plurality of planetary gears 64 and may be secured to the support member 10 through the steering housing part 50. In an example, the carrier 65 may include a first carrier part 651 inducing an interlocked rotation between the plurality of planetary gears 64 and the sun gear 63 while maintaining the spacing therebetween, and a second carrier part 652 extending from the first carrier part 651. The second carrier part 652 may be fixedly installed on the first upper connection portion 131 through the second housing portion 52. As a result, the carrier 65 is restricted from self-rotating, and the planetary gears 64 may be rotated on an axis without being circumferentially offset. Additionally, steering angle sensors 653 may be rotatably mounted on the second carrier part 652 to surround the second carrier part 652. The steering angle sensors 653 may be interlocked with the steering housing part 50 in an interworking manner so that the steering angle sensors may measure the steering angle while rotating with the interworking steering housing part 50.

The ring gear 66 may be disposed to surround the planetary gears 64 and engage with the steering housing part 50 to output rotational force to the steering housing part 50. In an example, an inner circumferential surface of the ring gear 66 may engage with the planetary gears 64, and an outer circumferential surface of the ring gear 66 may engage with the fifth housing portion 55.

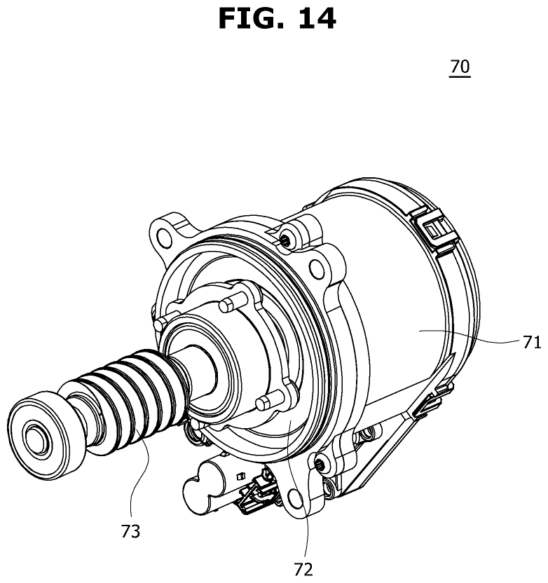

FIG. 14 is a diagram schematically illustrating a steering motor part according to an embodiment of the present disclosure. Referring to FIG. 14, the steering motor part 70 may include a motor casing portion 71, a motor drive portion 72, and a motor shaft portion 73.

The motor casing portion 71 may be mounted on the steering housing part 50. In an example, the motor casing portion 71 may be coupled to the side of the first housing portion 51 to cover the connection hole 58. The motor drive portion 721 may be accommodated in the motor casing portion 71.

The motor shaft portion 73 may be connected to the motor drive portion 72 and may be inserted into the steering housing part 50 to provide rotational force to the steering gear part 60. In an example, the motor shaft portion 73 is inserted into the first housing portion 51 through the connection hole 58. The motor shaft portion has a length of rod with a geared outer circumferential surface, and may be rotated on an axis. The motor shaft portion 73 may be interlocked with the worm gear 61 to rotate the worm gear 61.

The operation of the vehicle suspension system having the above structure according to an embodiment of the present disclosure will be described as follows.

When the steering gear part 60 and the steering motor part 70 are mounted on the steering housing part 50, the motor shaft portion 73 engages the worm gear 61, and the carrier 65 passes through the second housing portion 52. Then, the fifth housing portion 55 extending downwardly from the second housing portion 52 engages with the ring gear 66, which is responsible for the output of the steering gear 60.

In order to mount the assembled steering section 30 on the in-wheel motor section 40, the third housing portion 53 is engaged with the central portion of the in-wheel motor section 40.

When the third housing portion 53 is coupled to the in-wheel motor section 40, the fourth housing portion 54 is supported on the lower arm portion 17 via the lower ball joint portion 16, and the upper connection portion 13, which is combined with the externally exposed carrier 65, is supported on a pair of upper arm portions 15 via the upper ball joint portion 14. In addition, the shock absorber 20 is connected to the lower support part 12 to absorb the road surface impact.

When power is applied to the steering motor part 70 in the above state, the motor shaft portion 73 is rotated to rotate the worm gear 61. When the worm gear 61 is rotated, the sun gear 63 connected to the worm gear 61 is rotated. When the sun gear 63 is rotated, three planetary gears 64 engaged with the sun gear 63 are rotated without changing their position while being supported on the carrier 65 to rotate the ring gear 66. When the ring gear 66 is rotated, the steering housing part 50 having the fifth housing portion 55 engaged with the ring gear 66 is rotated. This makes it possible to adjust the steering angle of the wheel 200 to which the in-wheel motor section 40 is coupled.

In the vehicle suspension system 1 according to the present disclosure, the steering section 30 is mounted on the in-wheel motor section 40 coupled to the wheel 200, thereby enabling independent steering angle adjustment of the wheel 200. As a result, the conventional tie rods may be eliminated to realize various driving modes (zero turn, oblique driving, crab driving).

In FIG. 2, an imaginary line connecting the carrier 65 and the lower ball joint portion 16 becomes a steering axis x, and an imaginary line connecting the lower ball joint portion 16 and the upper ball joint portion 14 becomes a motion axis y for the suspension. Since the steering axis x and the motion axis y are pivotally spaced apart from each other, the steering angle may be increased and the alignment may be stably maintained during a large amount of steering.

Suspensions with conventional vertical steering systems eliminate tie rods that affect toe and camber changes during wheel bump and rebound behavior, reducing the wheel alignment affecting factor. Therefore, it is not possible to develop driving performance equivalent to that of a general mass-produced vehicle.

The vehicle suspension system 1 according to an embodiment of the present disclosure may be developed such that the second upper arm 152 is provided to act as the tie rod to have K&C characteristics equivalent to those of a mass-produced vehicle, and the hard points of the upper arm portion 15 and the lower arm portion 17 are corrected in a small amount within an oscillating angle range to satisfy the rear wheel K&C characteristics. Therefore, the degree of freedom in design for the front and rear wheels may be increased and parts sharing and standardization may be obtained.

The vehicle suspension system 1 according to an embodiment of the present disclosure is configured such that the steering section 30 is pivotably supported on the support member 10 and the steering angle of the wheel 200 and the in-wheel motor section 40 coupled to the steering section 30 is independently regulated, so that tie rods may be eliminated to implement various driving modes as well as to improve driving stability.

While the present disclosure has been described with reference to the embodiments illustrated in the drawings, these embodiments are exemplary only, and one of ordinary skill in the art will understand that various modifications and other equivalent embodiments are possible therefrom. Accordingly, the scope of technical protection of the present disclosure is to be defined by the following claims.

What is claimed is:

1. A vehicle suspension system comprising:
a support member coupled to a vehicle body;
a shock absorber connecting the support member and the vehicle body and absorbing a road surface impact;
a steering section pivotably mounted on the support member; and
an in-wheel motor section coupled to the steering section in an interworking manner and mounted on a wheel to provide driving force.

2. The vehicle suspension system of claim 1, wherein the support member includes:
an upper support part to which an upper portion of the steering section is coupled; and
a lower support part to which a lower portion of the steering section is pivotably coupled.

3. The vehicle suspension system of claim 2, wherein the upper support part includes:
an upper connection portion coupled to the steering section;
an upper ball joint portion coupled to the upper connection portion; and
a plurality of upper arm portions pivotably mounted in an axial direction of the upper ball joint portion and connected to the vehicle body.

4. The vehicle suspension system of claim 3, wherein the upper ball joint portion includes a plurality of upper ball joint portions that is spaced apart from each other, and the plurality of upper arm portions are mounted on the plurality of upper ball joint portions, respectively.

5. The vehicle suspension system of claim 2, wherein the lower support part includes:
a lower ball joint portion coupled to the steering section; and
a lower arm portion on which the lower ball joint portion is pivotably mounted, which is coupled to the vehicle body, and to which the shock absorber is connected.

6. The vehicle suspension system of claim 1, wherein the steering section includes:
a steering housing part combined with the in-wheel motor section;
a steering gear part pivotably accommodated in the steering housing part and coupled to the support member; and
a steering motor part mounted on the steering housing part to provide rotational force to the steering gear part.

7. The vehicle suspension system of claim 6, wherein the steering housing part includes:
a first housing portion combined with the steering motor part to accommodate the steering gear part therein and having an upper housing hole;
a second housing portion that is combined with the first housing portion to cover the housing hole and through which a portion of the steering gear part passes;
a third housing portion extending from the first housing portion and combined with the in-wheel motor section; and
a fourth housing portion extending from the third housing portion and combined with the support member.

8. The vehicle suspension system of claim 7, wherein the steering housing part further includes:
a fifth housing portion formed in the second housing portion and meshed with a portion of the steering gear part.

9. The vehicle suspension system of claim 6, wherein the steering gear part includes:
a worm gear pivotably mounted on the steering housing part and meshed with the steering motor part to rotate therewith;
a sun gear interlocked with the worm gear to rotate therewith;
a plurality of planetary gears circumferentially disposed around the sun gear in a mutually meshed manner to rotate therewith;
a carrier supporting the plurality of the planetary gears and fixed to the support member through the steering housing part; and
a ring gear disposed around the planetary gears and connected to the steering housing part to output rotational force to the steering housing part.

10. The vehicle suspension system of claim 6, wherein the steering motor part includes:
a motor casing portion mounted on the steering housing part;
a motor drive portion accommodated in the motor casing portion; and
a motor shaft portion connected to the motor drive portion and inserted into the steering housing part to provide rotational force to the steering gear part.
